(19) United States
(12) Patent Application Publication
(10) Pub. No.: US 2026/0286935 A1
(43) Pub. Date: Sep. 24, 2026

(54) WIND ENERGY HARVESTER

(71) Applicant: ARCHIMEDES IP PTY LTD, Darlington (AU)

(72) Inventor: Kenneth John Davey, Darlington (AU)

(73) Assignee: ARCHIMEDES IP PTY LTD, Darlington, WA (AU)

(21) Appl. No.: 19/474,092

(22) PCT Filed: Apr. 9, 2024
(86) PCT No.: PCT/AU2024/050337

§ 371 Date: Oct. 9, 2025

(30) Foreign Application Priority Data
Apr. 12, 2023 (AU) 2023901067

(51) Int. Cl. F03D 5/06

(52) U.S. Cl. CPC F03D 5/06; F05B 2210/16

(57) ABSTRACT

Provided is a wind energy harvester 10 comprising a turntable platform 12 positionable on a surface 14 and comprising a generator 16. Harvester 10 includes at least one elongate support boom 18 pivotably arranged at one proximal end 20 thereof on said turntable platform 12 such that the support boom 18 is oscillatable, and configured such that oscillations thereof actuates said fluid pump 16. Harvester 10 also includes a high-lift aerofoil 24 swivelably arranged at a distal end 22 of said support boom 18 to stand proud of the turntable platform 12 and surface 14, an orientation arrangement 26 configured to invert the aerofoil 24 between oscillations to maintain a desired angle of attack of said aerofoil 24 relative to the turntable 12 during such oscillation, and a wind vane arrangement 28 arranged on the support boom 18 between the proximal and distal ends 20 and 22 of the support boom 18 and which is configured to correct the angle of attack of said aerofoil 24 according to a relative wind direction relative to the turntable 12. In this manner, oscillation of the support boom enables wind energy harvesting via the generator.

### TECHNICAL FIELD

This invention relates broadly to the field of renewable energy, in general, and more particularly to a wind energy harvester for harvesting energy from a fluid, such as wind.

### BACKGROUND ART

The following discussion of the background art is intended to facilitate an understanding of the present invention only. The discussion is not an acknowledgement or admission that any of the material referred to is or was part of the common general knowledge as at the priority date of the application.

The concept of harvesting energy from fluid flow, i.e. wind, water, etc., has been around for hundreds of years, with archaeological evidence showing use of watermills in Egypt, India, Greece, and other parts of Eurasia from the fourth to third centuries B.C.E. Similarly, the wind-powered organ of the Greek engineer Heron of Alexandria in the first century is the earliest known instance of using a wind-driven wheel to power a machine; however, wind power has been used as long as humans have put sails into the wind.

The incentive to use more and more renewable energy, for electricity, transport, or even total primary energy supply globally, has been motivated by global warming and other ecological as well as economic concerns, such as sustainability and pollution. The most significant barriers to the widespread implementation of large-scale renewable energy and low carbon energy Strategies are primarily political rather than technological, and rapid reliance on renewable energy sources is occurring on a global scale. Wind power, as an alternative to burning fossil fuels, is plentiful, renewable, widely distributed, clean, produces no greenhouse gas emissions during operation, consumes no significant water during operation, and uses relatively little land.

Wind power is a variable renewable energy, so power-management techniques are generally required to match supply and demand. In the past, various different devices have been proposed and produced to recover wind energy and all have varying limitations regarding ease of manufacture, operation, maintenance, limits of size, stress and the ability to handle adverse weather conditions.

For example, some of these conventional wind energy harvesters are described in U.S. Pat. No. 4,470,770 to Grose; U.S. Pat. No. 4,184,805 to Arnold; U.S. Pat. No. 3,995,972 to Nassar; U.S. Pat. No. 2,465,285 to Schwickerath; U.S. Pat. No. 1,302,889 to Albisu; U.S. Pat. No. 1,281,618 to McGregor; U.S. Pat. No. 1,221,090 to Prewitt et al; U.S. Pat. No. 276,939 to Trumble; U.S. Pat. No. 258,650 to Howland; U.S. Pat. No. 237,851 to Foskett; U.S. Pat. No. 170,326 to Armour; and U.S. Pat. No. 148,927 to Chaplin.

The Grose patent discloses apparatus that includes a self-orientating elevated and elongated boom centrally pivoted with free wings at each end that tilt oppositely in concert with the aid of various control panels. Each wing has independent right- and left-wing sections free to accommodate differential wind loads, provision for stacked wings, and forward and rearward sweep. The rocking motion is applied to drive, by a wind velocity-controlled stroke, a double-acting hydraulic pump.

The Arnold patent discloses apparatus that includes provision of a rotary mount and rudder for orienting the same into the wind, and which extracts wind energy by a plurality of fluttering aerofoils.

The Nassar patent discloses an aerofoil mounted for vertical reciprocation with means for mechanically changing the angle of attack upon reaching each of its limiting positions so as to be urged toward the other.

The Schwickerath patent discloses a wing mounted upon the aft end of a member mounted for vertical oscillation about a transverse pivot at its forward end of the member. Wind actuated means, adjacent the pivot, are provided for directly mechanically controlling the attitude of the wing relative to the oscillating member. The structure is to orient itself into the wind.

The Albisu patent discloses a vertical member that may oscillate, having a wing or vane at its aft end. The angle of attack by the wing relative to the member or boom is limited between two extremes by structure carried by the member constituting physical constraints. The mounting of the wing on the member is such that the former is forced to one of such extremes by reason of the fact that the aerodynamic centre of the resultant force is ahead of the wing rotation point, which causes the angle of attack to diverge until stopped by one of the physical constraints.

The McGregor patent discloses vertical arrays of lifting surfaces at the right and left ends of a centrally pivoted boom. Means are provided for mechanically reversing the angle of attack of the lifting surfaces upon their reaching limiting rocking positions of the oscillating member.

The Prewitt et al patent discloses structure generally similar to that of the Albisu patent except that a vertical array of lift surfaces is provided rather than a single lifting surface.

The Trumble patent discloses structure generally similar to that of the Albisu patent, together with means enabling the limiting positions to be adjusted during operation from a remote location by an attendant.

The Foskett patent discloses apparatus that is generally similar in principle to the structure disclosed in the Albisu patent, differing primarily in the character of the physical constraint provided.

The Chaplin patent discloses a centrally pivoted, vertically oscillating member provided with lift surfaces at both its forward and aft ends. A control system is provided such that one of such surfaces is active at one time.

The Applicant has identified shortcomings in such conventional apparatus as being generally reliant on being mounted on towers above the ground to avoid airflow turbulence and for exposure to somewhat consistent air flow unrestrained from surface structures and variations. As a consequence, such conventional apparatus are typically structurally limited for handling adverse weather conditions, as well as being awkward and costly to erect and carry out maintenance.

For example, conventional wind turbines have structural limitations of size and area required for the air screw. A fundamental problem of using a conventional wing section for power generation at low wind speeds is the limited lift that can be developed. Additionally, when the blades stop in light wind conditions they become effectively stalled and require considerable external power input to get their rotation underway when the wind increases. Wind turbines have further shortcomings such as environmental constraints due to bird strikes, radio transmission interference, turbulence, etc. In addition, prior art apparatus generally comprise aerofoil sections that are not optimised for light wind conditions, typically being the most common weather condition.

The present invention was conceived with the goal in mind of providing a simple, low-cost device having a low degree of mechanical stress during use and, hence, a reduced limit on its size of construction, as well as simple load matching to the available wind strength for constant speed operation, and the ability to lie close to the ground for ease of erection and maintenance or to be secured in the event of extreme weather.

### SUMMARY OF THE INVENTION

The skilled addressee is to appreciate that reference herein to an ‘airfoil’ (American English) or ‘aerofoil’ (British English) comprises broad reference to any suitable object whose motion through a fluid is capable of generating lift, such as a wing or a sail. Such lift on an aerofoil is primarily the result of its angle of attack, i.e. when the aerofoil is oriented at a suitable angle, the aerofoil deflects the oncoming fluid resulting in a force on the aerofoil in the direction opposite to the deflection. With an aerofoil, an upper surface is generally associated with higher fluid velocity and lower static pressure, and a lower surface has a comparatively higher static pressure than the upper surface. A fluid pressure gradient between these upper and lower surfaces contributes to the lift force generated for a given aerofoil.

The geometry of an aerofoil is typically described according to a leading edge which is the point at the front of the aerofoil that has maximum curvature (minimum radius), a trailing edge is defined similarly as the point of maximum curvature at the rear of the airfoil, a chord line is the straight line connecting leading and trailing edges, and the chord length or simply chord is the length of the chord line. The shape of an aerofoil is generally defined using the geometrical parameters of mean camber line or mean line being the locus of points midway between the upper and lower surfaces, with a shape determined by the thickness distribution along the chord. Typically, a high camber aerofoil provides a high lift coefficient.

Similarly, it is to be appreciated that reference herein to fluid comprises reference to a liquid and/or a gas. For example, while preferred embodiments are described as harvesting wind energy, the skilled addressee is to appreciate that harvesting energy from a liquid in motion is apposite and expressly included herein.

According to an aspect of the invention there is provided a wind energy harvester comprising:
a turntable platform positionable on a surface and comprising a generator;
at least one elongate support boom pivotably arranged at one proximal end thereof on said turntable platform such that the support boom is oscillatable, and configured such that oscillations thereof actuates said generator;
an aerofoil swivelably arranged at a distal end of said support boom to stand proud of the turntable platform and surface; and
an orientation arrangement configured to invert the aerofoil between oscillations to maintain a desired angle of attack of said aerofoil relative to wind passing over the surface during such oscillation,
wherein the orientation arrangement comprises a changeover mechanism which comprises a stroke changer arm linked to the aerofoil and arranged in contact with a roller operatively actuating a cam link rod and attached cam rotatably fast with the turntable, the changeover mechanism configured such that when the support boom reaches an apex or nadir of oscillation, the stroke changer arm inverts the aerofoil via a parallelogram linkage, so that oscillation of the support boom enables wind energy harvesting via the generator.

In an embodiment, the turntable comprises a rotary platform configured to support the at least one support boom, aerofoil and orientation arrangements thereon on the surface, such as the ground, so that the aerofoil is automatically rotatably orientable into a wind direction under influence of such wind.

In an embodiment, the generator comprises a fluid pump for pumping a fluid, an electromechanical generator, or the like.

In an embodiment, the fluid pump comprises one or more variable stroke double or single acting reciprocating fluid pumps for creating fluid pressure under influence of the oscillating of the at least one support boom.

In an embodiment, the electromechanical generator comprises a direct-drive electrical generator.

In an embodiment, the support boom with aerofoil is pivotably counterbalanced on said turntable platform, i.e. arranged in rotational equilibrium.

In an embodiment, the at least one elongate support boom is weighted at the proximal end thereof to counterbalance a weight of the aerofoil and optionally the orientation and wind vane arrangements in order to facilitate oscillation of said boom.

In an embodiment, the support boom is arranged to be oscillatable in a substantially upward and downward direction relative to the surface.

In an embodiment, the aerofoil comprises a high-lift aerofoil having a high-camber chord configuration, with strengthening webs arranged between a leading and trailing edge thereof for swivelable mounting to the distal end of the at least one support boom.

In an embodiment, the aerofoil is mounted to the distal end of the at least one support boom via suitable bearings to facilitate oscillation of the aerofoil relative to the at least one support boom.

In an embodiment, the high-lift aerofoil is arranged to stand proud of the turntable to facilitate exposure to wind passing over the surface.

In an embodiment, the orientation arrangement comprises the parallelogram linkage arranged between the aerofoil and along the support boom and configured to maintain the angle of attack of said aerofoil relative to the turntable regardless of an angle of said boom during oscillation.

In an embodiment, the changeover mechanism is arranged between the turntable platform and aerofoil and configured to invert the aerofoil between oscillations to maintain a desired angle of attack of said aerofoil relative to wind direction incident on a leading edge thereof.

In an embodiment, the wind energy harvester comprises a wind vane arrangement arranged on the support boom between the proximal and distal ends of the support boom and configured to correct the angle of attack of said aerofoil according to a relative wind direction incident on a leading edge thereof.

In an embodiment, the wind vane arrangement is arranged on the support boom between the proximal and distal ends to reduce a loading on the distal end and to maintain the wind vane arrangement clear of the downwash of the aerofoil, in use.

In an embodiment, the wind vane arrangement comprises a wind vane configured to interact with the parallelogram linkage of the changeover mechanism to urge the angle of attack of said aerofoil according to a relative wind direction incident on a leading edge thereof.

In an embodiment, the orientation arrangement comprises a support boom stroke adjuster which is configured to adjust an oscillation stroke distance of the support boom.

In an embodiment, the support boom stroke adjuster is linked with the parallelogram linkage of the changeover mechanism and the wind vane to affect the orientation arrangement and set the oscillation stroke distance of the support boom to relieve mechanical loading during inversion of said aerofoil.

In an embodiment, the support boom stroke adjuster comprises two impediments each respectively impeding oscillating movement of the stroke changer arm effectively to determine the apex or nadir of oscillation of the support boom, thereby setting the oscillation stroke distance of the support boom.

In an embodiment, the generator is configured to store harvested wind energy as potential energy, electrochemical energy, or the like, such as fluid stored at height and/or fluid stored under high pressure, charging an electrochemical cell or battery, etc.

In an embodiment, the fluid pump is configured to actuate a mechanical generator using harvested fluid pressure energy.

According to a further aspect of the invention there is provided a wind energy harvester substantially as herein described and/or illustrated.

### BRIEF DESCRIPTION OF THE DRAWINGS

The description will be made with reference to the accompanying drawings in which:

FIG. 1 is a diagrammatic perspective-view representation of one possible embodiment of a wind energy harvester, in accordance with aspects of the present invention;

FIG. 2 is a diagrammatic side-sectional representation of the wind energy harvester of FIG. 1;

FIG. 3 is diagrammatic side-view representation of one embodiment of an orientation and wind vane arrangement of the wind energy harvester of FIG. 1;

FIG. 4 is a diagrammatic side-view representation of the orientation and wind vane arrangement of FIG. 3, in use;

FIG. 5 is a diagrammatic side-view functional representation of operation of a high-lift aerofoil by way of background;

FIG. 6 is a diagrammatic closer-view representation of a changeover mechanism of the orientation arrangement of FIG. 3;

FIG. 7 is a diagrammatic functional representation of the wind vane arrangement of FIG. 3, in use; and

FIG. 8 provides diagrammatic sequential operational representations of the changeover mechanism of FIG. 6 during oscillation of the support boom of the wind energy harvester.

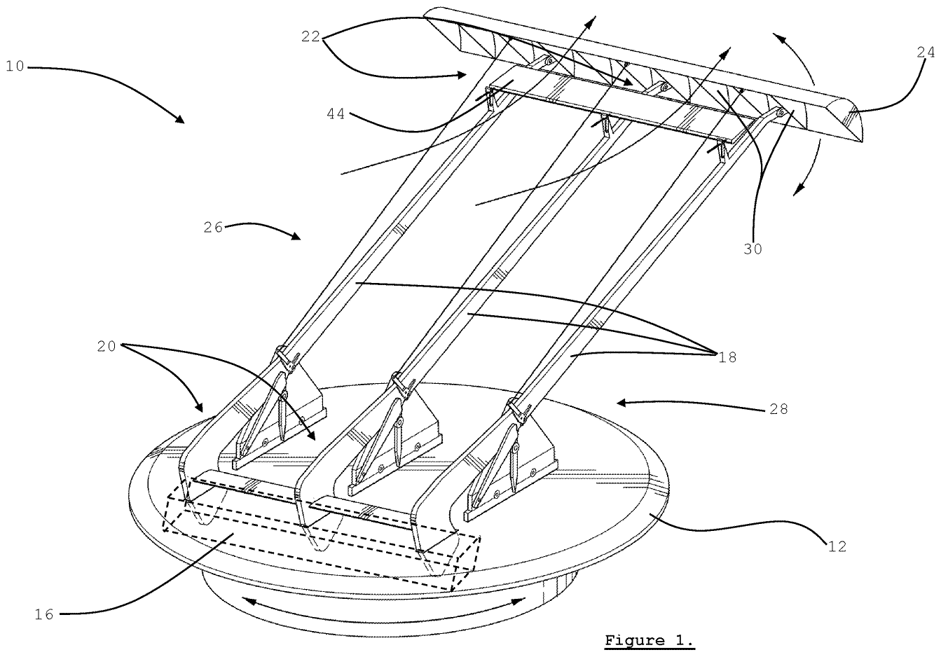

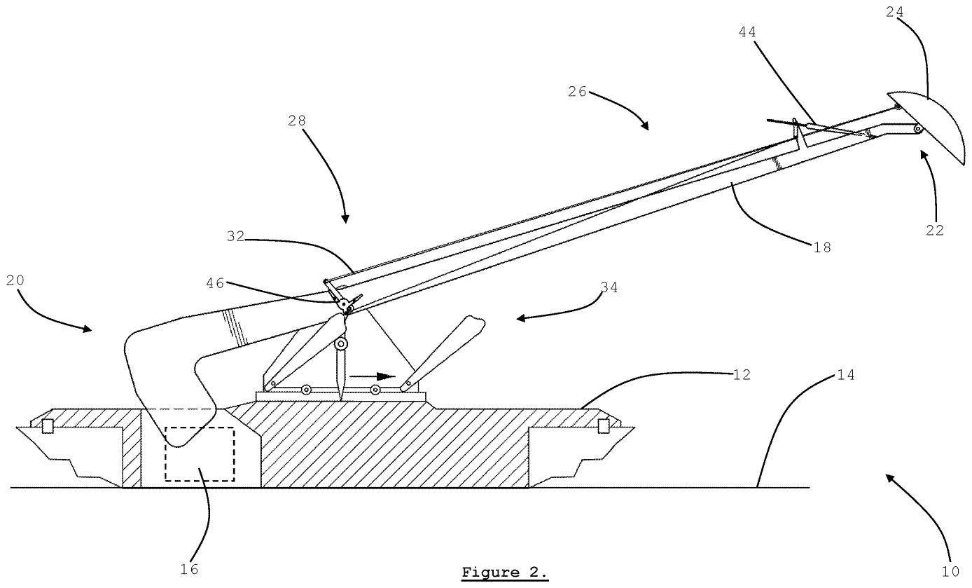

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

Additionally, the accompanying figures do not represent engineering or design drawings, but provide a functional overview of the invention only. As a result, features and practical construction details required for various embodiments may not be expressly indicated in each figure, but such construction requirements will be within the understanding of the skilled addressee.

Broadly, the present invention provides for a wind energy harvester 10 configured to harvest wind energy and convert such harvested energy into other types of energy, such as fluid flow and/or pressure, electrical energy, mechanical energy, or the like. The skilled addressee is to appreciate, however, that other embodiments may forego the use of fluid pressure where harvested energy is converted to mechanical energy, e.g. direct mechanical actuation of an electromechanical generator, or the like. In general, the wind energy harvester 10 of the present invention comprises a turntable platform 12, at least one elongate support boom 18 supporting a high-lift aerofoil 24 distal from the turntable 12 such that it is able to oscillate due to passing wind, as well as an orientation arrangement 26 and wind vane arrangement 28 both configured to adjust an orientation and/or angle of attack of the aerofoil 24 to maximise wind energy harvesting, i.e. lift force on the aerofoil 24 during oscillations.

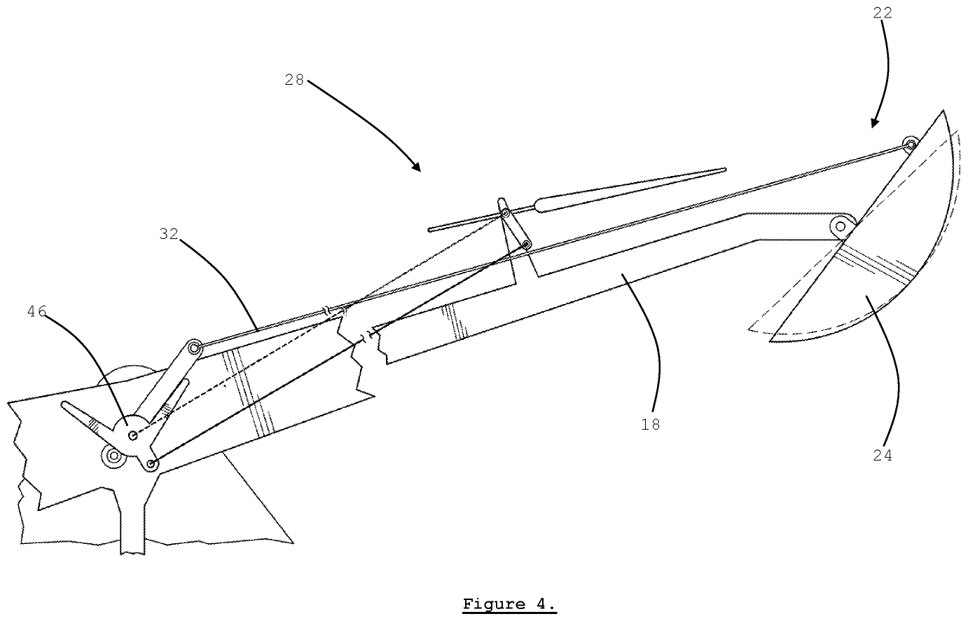

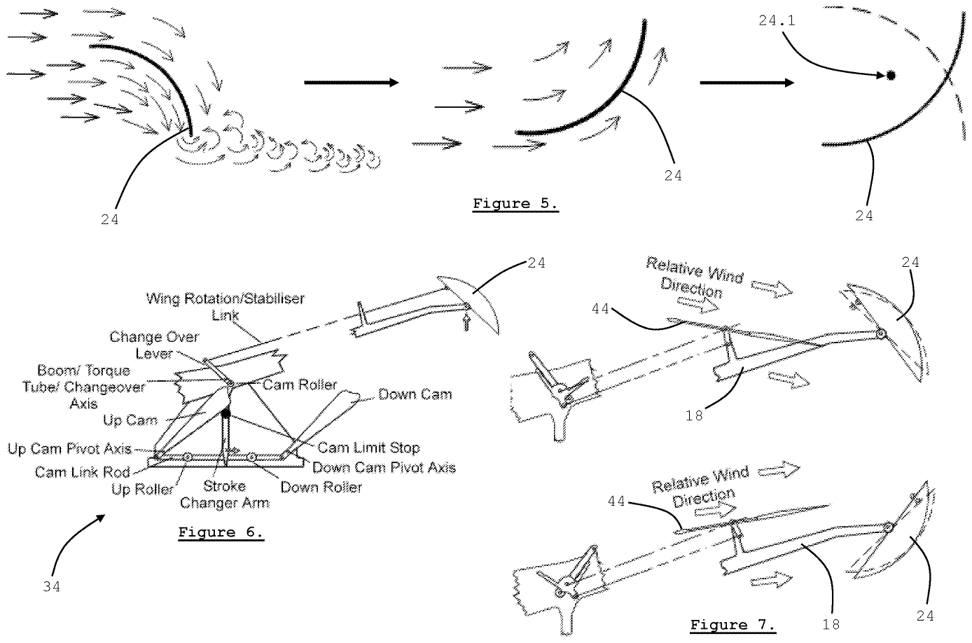

For background purposes, with reference firstly to FIG. 5 of the accompanying drawings, a fundamental problem of using a conventional wing section for power generation at low wind speeds in oscillatory motion, is the limited lift that can be developed. For example, a normal aircraft having to reach take-off speed before producing appreciable lift is an example of such phenomena. Accordingly, an aerofoil 24 able to produce high-lift in low-wind conditions is proposed as part of the energy harvester 10.

Most common aerofoils produce about ⅔rd lift over the top surface and, in fact, a high thickness-to-chord ratio non-symmetric aerofoil, at zero angle of attack, is able to produce all of its lift from the upper surface alone. The improvement in lift with this particular aerofoil shape is quite pronounced compared with a normal aerofoil and is likely due to a progressive slowing of the speed of the air in the downwash on the underside of the curve of such an aerofoil.

Further, the continuing curve of the upper surface would induce a progressive increase in the speed of the air in the downwash on the upper side of the curve to encourage laminar flow and decreased static pressure. The poor lift/drag ratio due to turbulent flow from the merging upper and lower airflow would be of lesser concern as the aerofoil is tethered, unlike the considerations of a flying aircraft. Accordingly, the proposed high-lift aerofoil 24 more closely relates to that of a fan or blower. Unlike a symmetrical conventional aerofoil, where the angle of attack can be maintained and then changed easily at the end of the stroke of the device, similar changing of the angle of this highly curved high-lift aerofoil is impractical.

As indicated in FIG. 5, reversing the airflow over the aerofoil solves some of the problem, as shown in FIG. 5. The change in configuration from the upward stroke (represented by dotted line) to the downward stroke (indicated by solid line) is achieved by rotating the section about a predetermined axis shown at point 24.1. Such rotation of the aerofoil 24 is accomplished via the orientation arrangement 26, which is configured to invert the aerofoil 24 between oscillations to maintain a desired angle of attack thereof relative to the turntable 12 during such oscillation, as explained in more details below.

Referring now to the accompanying figures, one embodiment of the wind energy harvester 10 comprises a turntable platform 12 which is positionable on a surface 14, such as the ground, and further includes a generator 16, such as a fluid pump for pumping a fluid, an electromechanical generator, or the like. Other types of generators are possible and anticipated.

In one embodiment, the turntable 12 comprises a rotary platform configured to support the at least one support boom 18, aerofoil 24 and orientation and wind vane arrangements 26 and 28 thereon on the surface 14, such as the ground, so that the aerofoil 22 is automatically rotatably orientable into a wind direction under influence of such wind.

In one embodiment, the fluid pump 16 comprises one or more variable stroke double or single acting reciprocating fluid pumps for creating fluid pressure under influence of the oscillating of the at least one support boom 18. In such an embodiment, the fluid pump 16 is typically configured to store harvested wind energy as potential energy of fluid stored at height and/or fluid stored under high pressure. Accordingly, the harvester 10 may be used for electrical power generation having firstly generated a store of fluid at height and/or under pressure.

Alternatively, or additionally, in one embodiment the fluid pump 16 is configured to actuate an electromechanical generator using harvested fluid pressure energy directly, e.g. hydraulic direct actuation of an electrical generator, direct mechanical actuation, or the like. As mentioned above, variations are possible where the fluid pump 16 is replaced with other energy conversion means, such as a geared mechanism driving an electrical generator, or the like. Accordingly, the term ‘generator’ 16 may denote any suitable device or equipment to convert or change the mechanical energy of the oscillating support boom 18 to another form of energy, e.g. potential, electrochemical, mechanical, or the like.

The energy harvester 10 includes at least one elongate support boom 18 which is pivotably arranged at one proximal end 20 thereof on the turntable platform 12, a shown, such that the support boom 18 is oscillatable, with the support boom 18 and generator 16 arranged and configured such that oscillations of the boom 18 actuates said generator 16. In the exemplified embodiment, the harvester 10 includes three side-by-side elongate booms 18, as shown, but variations hereon are possible and expected.

In one embodiment, the at least one elongate support boom 18 is weighted at the proximal end 20 thereof to counterbalance a weight of the aerofoil 24 and optionally the orientation and wind vane arrangements 26 and 28 in order to facilitate oscillation of said boom, i.e. a balanced boom arrangement so that lift from the aerofoil 24 is maximised for energy harvesting. For example, the proximal end 20 may define a suitable water reservoir for receiving a mass of water therein to act as counterweight, or the like. Typically, the support boom 18 is arranged to be oscillatable in a substantially upward and downward direction relative to the surface 14, but variations hereon are possible and anticipated.

The high-lift aerofoil 24 is swivelably arranged at a distal end 22 of the support boom 18 in order to stand proud of the turntable platform 12 and surface 14, as shown. The aerofoil 24 is generally proud or somewhat above the turntable to expose the aerofoil to wind passing over the surface and to minimise interference and turbulence resulting from the turntable 12 and other surface structures.

Typically, as explained previously, the high-lift aerofoil 24 comprises a high-camber chord configuration, with strengthening webs 30 arranged between a leading and trailing edge thereof for swivelable mounting to the distal end 22 of the at least one support boom 18. In one embodiment, the aerofoil 24 is mounted to the distal end 22 of the at least one support boom 18 via suitable bearings (not shown) to facilitate oscillation of the aerofoil 24 relative to the at least one support boom 18, i.e. to minimise frictional losses.

The orientation arrangement 26 is broadly configured to invert the aerofoil 24 between oscillations to maintain a desired angle of attack of said aerofoil relative to the turntable 12 during such oscillation. In one embodiment, the orientation arrangement 26 comprises a parallelogram linkage 32 which is arranged between the aerofoil 24 and along the support boom 18 and which is configured to maintain the angle of attack of the aerofoil 24 relative to the turntable 12 regardless of an angle of said boom 18 during oscillation. For example, the orientation arrangement 26 is configured to change the angle of the aerofoil 24 for performing climb and descent oscillations by means of the parallelogram linkage 32. In such a manner, the parallelogram linkage 32 is able to maintain a substantially constant aerofoil angle with respect to the horizontal plane regardless of support boom 18 angle.

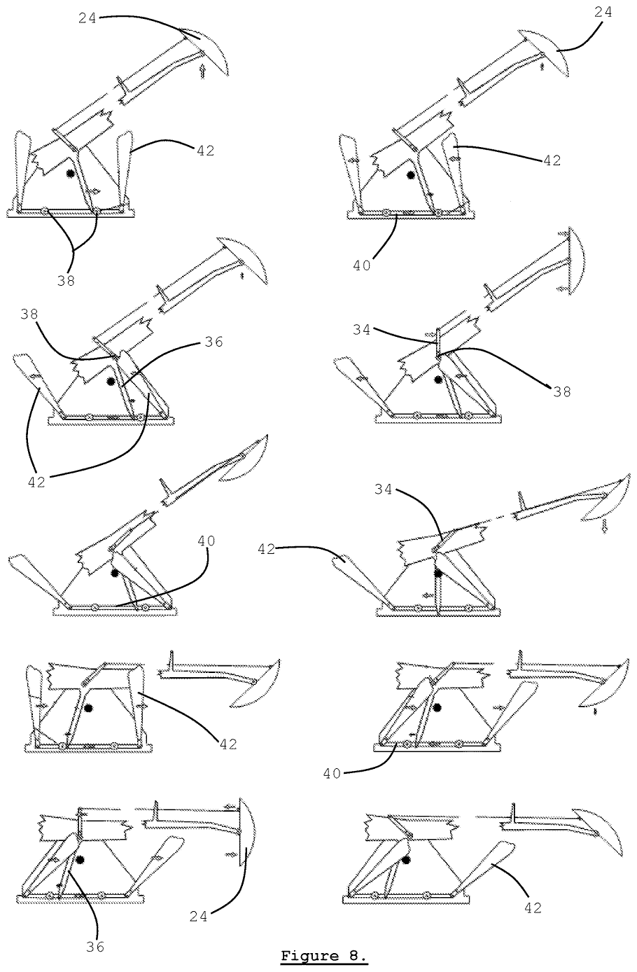

In one embodiment, the orientation arrangement 32 comprises a changeover mechanism 34 arranged between the turntable platform 12 and aerofoil 24 and which is configured to invert the aerofoil 24 between oscillations to maintain a desired angle of attack of said aerofoil 24 relative to the turntable 12. As shown more clearly in FIG. 6, in one embodiment, the changeover mechanism 34 comprises a stroke changer arm 36 linked to the aerofoil 24 and arranged in contact with a roller 38 operatively propelling a cam link rod 40 and attached cam 42 rotatably fast with the turntable 12, with the changeover mechanism 34 configured such that when the support boom 18 reaches an apex or nadir of oscillation, the stroke changer arm 36 inverts the aerofoil 24 via the parallelogram linkage 32.

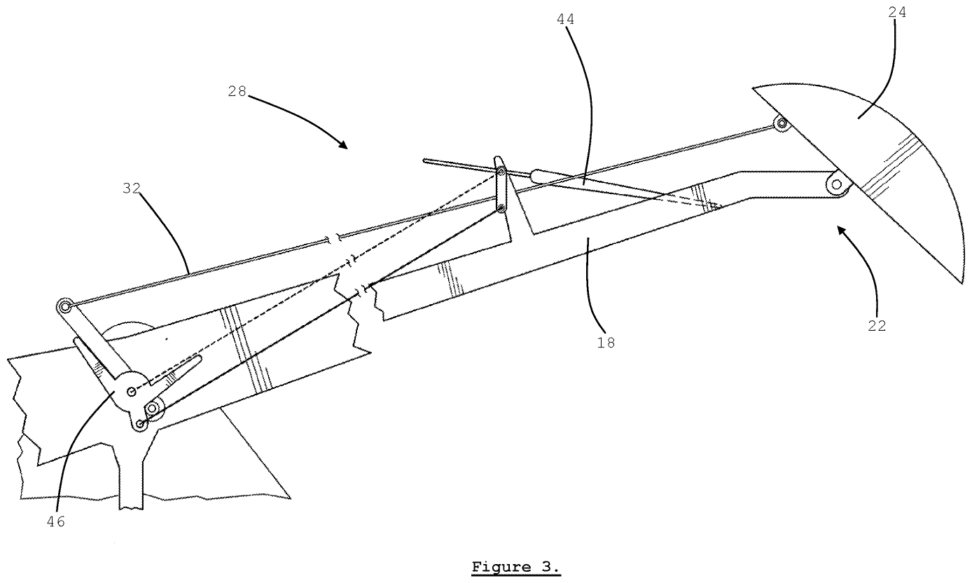

The energy harvester 10 also typically includes the wind vane arrangement 28 which is arranged on the support boom 18 between the proximal and distal ends 20 and 22 of the support boom 18 and which is configured to correct the angle of attack of the aerofoil 24 according to a relative wind direction relative to the turntable 12. Operation of the wind vane arrangement 28 is more clearly shown in FIGS. 3, 4 and 7.

In one embodiment, the wind vane arrangement 28 is arranged on the support boom 18 between the proximal and distal ends 20 and 22 to reduce a loading on the distal end 22 and to maintain the wind vane arrangement 28 clear of the downwash of the aerofoil 24, in use. In one embodiment, the wind vane arrangement 28 comprises a wind vane 44 which is configured to interact with the parallelogram linkage 32 of the orientation arrangement 26 to urge the angle of attack of said aerofoil 24 according to a relative wind direction incident on a leading edge thereof.

In one embodiment, the orientation arrangement 26 further comprises a support boom stroke adjuster 46 which is configured to adjust an oscillation stroke distance of the support boom 18. In the exemplified embodiment, the support boom stroke adjuster 46 is linked with the parallelogram linkage 32 of the changeover mechanism 34 and the wind vane arrangement 28 to affect the orientation arrangement 26 and set the oscillation stroke distance of the support boom 18, typically to relieve mechanical loading during inversion of the aerofoil 24. In the exemplified embodiment, the support boom stroke adjuster 46 comprises two impediments each respectively impeding oscillating movement of the stroke changer arm 36 effectively to determine the apex or nadir of oscillation of the support boom 18, thereby setting the oscillation stroke distance of the support boom 18. Of course, variations hereon are possible and expected, but will fall within the scope of mechanical equivalence.

With reference now to FIG. 8 of the accompanying drawings, there is exemplified progressive operation of the harvester 10 during oscillation, such sequence shown left-to-right and downwards as per conventional reading representation. The various moving parts of the harvester 10 are shown sequentially performing a changeover of the aerofoil angle during a complete cycle of oscillation of the boom 18. White arrows show relatively large movement whilst the small black arrows show comparatively smaller movement. Firstly, the stroke changer arm 36 is in contact with a down roller 38 propelling the cam link rod 40 and attached cams 42 towards instability, with the cams 42 moving rapidly beyond a point of stability. Both cams 42 rotate and the ‘down’ cam of cams 42 comes into contact with the cam roller 38 on the changeover lever 34.

The changeover lever 34 and aerofoil 24, linked via the parallelogram linkage 32, rotates due to the weight and momentum of the cam 42. This reaction is produced by about 1 degree of rotation of the boom/stroke changer arm 36. The down stroke then commences with the changeover lever and attached aerofoil 24 having completed rotation into the down stroke attitude, and the down cam 42 resting on a cam limit stop, with the aerofoil 24 descending. When the aerofoil 24 is almost at the bottom or nadir of its stroke, the stroke changer arm comes in contact with the ‘up’ roller, propelling the cam link rod 40 and attached cams 42 towards instability. As described above, the support boom stroke adjuster 46 may be used to impede a range of oscillating movement of the stroke changer arm 36, thereby effectively determining the apex or nadir of oscillation of the support boom 18, i.e. setting the oscillation stroke distance of the support boom 18.

The cams 42 with the ‘up’ cam then comes into contact with the cam roller 38 on the changeover lever 34. The cams 42 then continues to move and the ‘up’ cam rotates the changeover lever 34 and connected aerofoil 24. The changeover lever and attached aerofoil 24 having rotated into an ‘up’ orientation is then ready to commence the upward stroke. The changeover mechanism 34 now remains static until the aerofoil 24 approaches the top of the stroke and the cycle is repeated. The cams 42 may also be configured to be actuated or driven by the stroke changer arm 36, which may facilitate motive start-up of the energy harvester 10 when the wind reaches a suitable speed. Of course, variations on this mechanism of operation, such as a single cam, are possible and expected.

In the manner described, wind energy is harvestable via the generator 16, e.g. storable as fluid pressure potential energy, or is useable directly as a fluid pressure energy source, such as hydraulically actuation an electrical generator, direct mechanical actuation of a generator, direct drive mechanical generator, or the like.

Applicant believes it particularly advantageous that the present invention provides for a simple, low-cost harvester 10 having a low degree of mechanical stress during use and, hence, a reduced limit on its size of construction. In particular, harvester 10 provides a high-lift aerofoil 24 along with an orientation arrangement 26 which is configured to invert the aerofoil between oscillations to maintain a desired angle of attack of the aerofoil relative to wind passing over the surface during such oscillation. Harvester 10 may also comprise simple load matching to the available wind strength for constant speed operation, and has the ability to lie close to the ground surface for ease of erection and maintenance or to be secured in the event of extreme weather.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the contrivance in use or operation in addition to the orientation depicted in the figures. For example, if the contrivance in the figures is turned over, elements described as “below” or “beneath” other elements or features would then be oriented “above” the other elements or features. Thus, the example term “below” can encompass both an orientation of above and below. The contrivance may be otherwise oriented (rotated 90 degrees or at other orientations) and the spatially relative descriptors used herein interpreted accordingly.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

1-18. (canceled)

19. A wind energy harvester comprising:
a turntable platform positionable on a surface and comprising a generator;
at least one elongate support boom pivotably arranged at one proximal end thereof on said turntable platform such that the support boom is oscillatable, and configured such that oscillations thereof actuates said generator;
an aerofoil swivelably arranged at a distal end of said support boom to stand proud of the turntable platform and surface;
an orientation arrangement configured to invert the aerofoil between oscillations to maintain a desired angle of attack of said aerofoil relative to wind passing over the surface during such oscillation; and
a wind vane arrangement arranged between the proximal and distal ends of the support boom and configured to correct the angle of attack of said aerofoil according to a relative wind direction incident on a leading edge thereof;
wherein the orientation arrangement further comprises a changeover mechanism which comprises a stroke changer arm linked to the aerofoil and arranged in contact with a roller operatively propelling a cam link rod and attached cam rotatably fast with the turntable platform, the changeover mechanism configured such that when the support boom reaches an apex or nadir of oscillation, the stroke changer arm inverts the aerofoil via a parallelogram linkage, so that oscillation of the support boom enables wind energy harvesting via the generator.

20. The wind energy harvester of claim 19, wherein the turntable platform comprises a rotary platform configured to support the at least one support boom, aerofoil and orientation arrangement thereon on the surface, such as the ground, so that the aerofoil is automatically rotatably orientable into a wind direction under influence of such wind.

21. The wind energy harvester of claim 19, wherein the generator comprises a fluid pump for pumping a fluid, an electromechanical generator, or the like.

22. The wind energy harvester of claim 19, wherein the support boom with aerofoil is pivotably counterbalanced on said turntable platform, i.e. arranged in rotational equilibrium.

23. The wind energy harvester of claim 19, wherein the at least one elongate support boom is weighted at the proximal end thereof to counterbalance a weight of the aerofoil and optionally the orientation and wind vane arrangements in order to facilitate oscillation of said boom.

24. The wind energy harvester of claim 19, wherein the support boom is arranged to be oscillatable in a substantially upward and downward direction relative to the surface.

25. The wind energy harvester of claim 19, wherein the aerofoil comprises a high-lift aerofoil having a high-camber chord configuration, with strengthening webs arranged between a leading and trailing edge thereof for swivelable mounting to the distal end of the at least one support boom.

26. The wind energy harvester of claim 19, wherein the aerofoil is mounted to the distal end of the at least one support boom via suitable bearings to facilitate oscillation of the aerofoil relative to the at least one support boom.

27. The wind energy harvester of claim 19, wherein the orientation arrangement comprises the parallelogram linkage arranged between the aerofoil and along the support boom and configured to maintain the angle of attack of said aerofoil relative to the turntable regardless of an angle of said boom during oscillation.

28. The wind energy harvester of claim 19, wherein the changeover mechanism is arranged between the turntable platform and aerofoil and configured to invert the aerofoil between oscillations to maintain a desired angle of attack of said aerofoil relative to wind direction incident on a leading edge thereof.

29. The wind energy harvester of claim 19, wherein the wind vane arrangement is arranged on the support boom between the proximal and distal ends to reduce a loading on the distal end and to maintain the wind vane arrangement clear of the downwash of the aerofoil, in use.

30. The wind energy harvester of claim 19, wherein the wind vane arrangement comprises a wind vane configured to interact with the parallelogram linkage of the changeover mechanism to urge the angle of attack of said aerofoil according to a relative wind direction incident on a leading edge thereof.

31. The wind energy harvester of claim 19, wherein the orientation arrangement comprises a support boom stroke adjuster which is configured to adjust an oscillation stroke distance of the support boom.

32. The wind energy harvester of claim 32, wherein the support boom stroke adjuster is linked with the parallelogram linkage of the changeover mechanism and the wind vane to affect the orientation arrangement and set the oscillation stroke distance of the support boom to relieve mechanical loading during inversion of said aerofoil.

33. The wind energy harvester of claim 32, wherein the support boom stroke adjuster comprises two impediments each respectively impeding oscillating movement of the stroke changer arm effectively to determine the apex or nadir of oscillation of the support boom, thereby setting the oscillation stroke distance of the support boom.

34. The wind energy harvester of claim 19, wherein the generator is configured to store harvested wind energy as potential energy and/or electrochemical energy.

35. A wind energy harvester comprising:
a turntable platform positionable on a surface and comprising a generator;
at least one elongate support boom pivotably arranged at one proximal end thereof on said turntable platform such that the support boom is oscillatable, and configured such that oscillations thereof actuates said generator;
an aerofoil swivelably arranged at a distal end of said support boom to stand proud of the turntable platform and surface;
an orientation arrangement configured to invert the aerofoil between oscillations to maintain a desired angle of attack of said aerofoil relative to wind passing over the surface during such oscillation, said orientation arrangement comprising a changeover mechanism configured such that when the support boom reaches an apex or nadir of oscillation, the changeover mechanism inverts the aerofoil via a mechanical linkage; and
a wind vane arrangement arranged between the proximal and distal ends of the support boom and configured to correct the angle of attack of said aerofoil according to a relative wind direction incident on a leading edge thereof;
wherein oscillation of the support boom enables wind energy harvesting via the generator.

36. A wind energy harvester comprising:
a turntable platform positionable on a surface and comprising a generator;
at least one elongate support boom pivotably arranged at one proximal end thereof on said turntable platform such that the support boom is oscillatable, and configured such that oscillations thereof actuates said generator;
an aerofoil swivelably arranged at a distal end of said support boom to stand proud of the turntable platform and surface, said aerofoil comprising a high-lift aerofoil having a high-camber chord configuration, with strengthening webs arranged between a leading and trailing edge thereof for swivelable mounting to the distal end of the at least one support boom;
an orientation arrangement configured to invert the aerofoil between oscillations to maintain a desired angle of attack of said aerofoil relative to wind passing over the surface during such oscillation; and
a wind vane arrangement arranged between the proximal and distal ends of the support boom and configured to correct the angle of attack of said aerofoil according to a relative wind direction incident on a leading edge thereof;
wherein oscillation of the support boom enables wind energy harvesting via the generator.
